(19) United States
(12) Patent Application Publication
(10) Pub. No.: US 2014/0103101 A1
(43) Pub. Date: Apr. 17, 2014

(54) CONTAINER WITH MULTIPLE LAYERS HAVING INCREASED STACKUNG STRENGTH

(71) Applicant: Mauro Alvarado, JR., Cincinnati, OH (US)

(72) Inventor: Mauro Alvarado, JR., Cincinnati, OH (US)

(21) Appl. No.: 13/653,816

(22) Filed: Oct. 17, 2012

(51) Int. Cl. B65D 5/60; B31B 1/26; B65D 5/46

(52) U.S. Cl. CPC B65D 5/606; B65D 5/46072; B31B 1/26
USPC 229/117.12; 229/117.3; 229/190; 493/183

(57) ABSTRACT

A container comprising a cardboard enclosure having six sides, wherein the left side of the container and the right side of the container each comprises at least a first layer of cardboard and a second layer of cardboard for increased top load strength.

### FIELD OF THE INVENTION

The present invention relates to cardboard containers for holding a pourable product having multiple, overlapping sides for ease of assembly and increased stacking strength.

### BACKGROUND OF THE INVENTION

Containers including a fillable bladder and a foldable enclosure are known. One such container is the JERRIBOX brand container available from Scholle Packaging having offices at 200 West North Avenue, in Northlake, Ill. 60164.

However, existing containers suffer from drawbacks. One such drawback is that current containers use a high amount of cardboard per amount of waste which makes them more expensive to manufacture. In addition, existing containers also suffer in that the containers do not have maximum top load strength. Decreased top load strength prevents multiple containers from being layered on top of each other which takes up more space in the transport vehicle. As a result, fewer containers are able to be shipped. In addition, existing containers suffer from complicated assembly processes.

There is a need for a container that is constructed such that the sides of the container have increased top load strength for stacking multiple containers. In addition, there is a need for a container that is able to be assembled quickly without additional instruments. In addition, a need still exists for a container that is able to be manufactured with less cardboard waste.

### SUMMARY OF THE INVENTION

The present invention provides a container comprising a cardboard enclosure having six sides, wherein the six sides comprise a top side, a bottom side, a back side, a front side, a left side, and a right side, wherein the top side and the bottom side are opposing, wherein the left side and the right side are opposing, and wherein the left side and the right side each comprise at least a first layer of cardboard and a second layer of cardboard; and a fillable bladder positioned within the cardboard enclosure, an interior of the fillable bladder being accessible through a pour spout opening in the top side of the enclosure.

The present invention also provides for an unassembled container comprising a single piece of cardboard which is foldable to form an enclosure, the unassembled article comprising: a) a top side (701), a front side (702), a bottom side (703), and a back side (704), wherein the top side (701) is adjoining the front side (702) along a first fold line (109), wherein the front side (702) is adjoining the bottom side (703) along a second fold line (110), wherein the bottom side (703) is adjoining the back side (704) along a third fold line (111); b) the top side (701) comprising a first left flap (403) along a fourth fold line (101) and a first right flap (404) along a fifth fold line (105); c) the front side (702) comprising a second left panel (302) along a sixth fold line (102) and a second right panel (301) along a seventh fold line (106); d) the bottom side (703) comprising a second left flap (401) along an eighth fold line (103) and a second right flap (402) along a ninth fold line (107); e) the back side (704) comprising a first left panel (303) along a tenth fold line (104) and a first right panel (304) along an eleventh fold line (108), wherein the back side further comprises an attachment flap (600) along a twelfth fold line (112).

The present invention also provides for a method of constructing a container for holding a pourable product, the method including the steps of: Obtaining a single piece of cardboard which is foldable to form the enclosure, the single piece of cardboard including: a top side (701), a front side (702), a bottom side (703), and a back side (704), wherein the top side (701) is adjoining the front side (702) along first fold line (109), wherein the front side (702) is adjoining the bottom side (703) along second fold line (110), wherein the bottom side (703) is adjoining the back side (704) along third fold line (111); the top side (701) comprising a first left flap (403) along a fourth fold line (101) and a first right flap (404) along a fifth fold line (105); the front side (702) comprising a second left panel (302) along a sixth fold line (102) and a second right panel (301) along a seventh fold line (106); the bottom side (703) comprising a second left flap (401) along an eighth fold line (103) and a second right flap (402) along a ninth fold line (107); the back side (704) comprising a first left panel (303) along a tenth fold line (104) and a first right panel (304) along an eleventh fold line (108), wherein the back side further comprises an attachment flap (600) along a twelfth fold line (112), and further the top size (701) comprises at least a portion of a pour spout opening (10).

Folding the single piece of cardboard along fold lines (111) and (110) so that the front side (702) is generally parallel with the back side (704), and then folding along fold line (109) so that the top side (701) is generally parallel with the bottom side (703), and then folding the attachment flap (600) along fold line (112) followed by securing the attachment flap (600) to the exterior surface of the top side (701) along edge (226).

Folding the first right flap (404) along fold line (105) so that the first right flap (404) is perpendicular to the top side (701), and then folding the second right flap (402) along fold line (107) so that the second right flap (402) is perpendicular to the bottom side (703), and wherein further the first right flap (404) and second right flap (402) do not overlap.

Folding the first right panel (304) along fold line (108) so that the first right panel (304) is perpendicular to the top side (701) and wherein the first right panel (304) is parallel and adjacent to the first right flap (404) and the second right flap (402).

Folding the second right panel (301) along fold line (106) so that the second right panel (301) is perpendicular to the top side (701) and wherein the second right panel (301) is parallel and adjacent to the first right panel (304), and then securing the first right panel (304) to the second right panel (301).

Folding the first left flap (403) along fold line (101) so that the first left flap (403) is perpendicular to the top side (701), and then folding the second left flap (401) along fold line (103) so that the second left flap (401) is perpendicular to the bottom side (703), and wherein further the first left flap (403) and the second left flap (401) do not overlap.

Folding the first left panel (303) along fold line (104) so that the first left panel (303) is perpendicular to the top side (701) and wherein the first left panel (303) is parallel and adjacent to the first left flap (403) and the second left flap (401).

Folding the second left panel (302) along fold line (102) so that the second left panel (302) is perpendicular to the top side (701) and wherein the second left panel (302) is parallel and adjacent to the first left panel (303), and then securing the first left panel (303) to the second left panel (302).

Placing a fillable bladder (903) within a pour spout opening (10) into the enclosure formed by the container, the fillable bladder (903) being coupled to a holder (902) which is supported at the pour spout opening (10) by the container, the holder (902) including an opening (901) through which a pourable product may be placed into the interior of the fillable bladder (903).

Optionally placing the pourable product into the interior of the fillable bladder (903) and closing the opening (901) of the holder (902) to retain the pourable product in the interior of the fillable bladder (903).

### BRIEF DESCRIPTION OF THE DRAWINGS

The detailed description of the drawings particularly refers to the accompanying figures in which:

FIG. 1 is a perspective view of the container;

FIG. 2 is an exploded view of a container showing the enclosure formed by the container and a fillable bladder inserted into the enclosure;

FIG. 3 is a knocked down flat view of a single piece of material used to construct the container;

FIG. 4 is a perspective view of the container shown with the right and left side flaps and panels in an open position, and the top, bottom, front, and back sides in a folded state;

FIG. 5 is a perspective view of the container shown with the first right flap folded;

FIG. 6 is a perspective view of the container shown with the second right flap folded;

FIG. 7A is a perspective view of the container shown with the first right panel folded inside the second right panel to form the right side of the container;

FIG. 7B is a magnified view of the right side of the container with two layers of material; and

FIG. 8 is a perspective view of a container found in the prior art.

### DETAILED DESCRIPTION OF THE INVENTION

Within the context of this specification, each term or phrase below includes the following meaning or meanings:

“Adjacent” refers to structural elements that have no space in between the elements.

“Flap” refers to an element of the container that when the container is constructed, a flap is less than or equal to about 50% of the lateral surface area of a side of the container.

“Handle Opening” refers to a portion of the container that allows a user to insert his or her hands or fingers through to grasp the container.

“Layer” refers to a single piece of corrugated cardboard which is made up of fluted corrugated sheet between two flat linerboards.

“Panel” refers to a continuous element of the container that when the container is constructed, a panel is greater than 50% of the lateral surface area of a side of the container.

The present invention provides for a container having a left and a ride side, wherein the left side and the right sides each comprise at least a first layer of corrugated cardboard and a second layer of corrugated cardboard, in another embodiment at least three layers of corrugated cardboard.

It has been surprisingly found that a cardboard container that is constructed as detailed herein provides for increased top load strength for stacking. Specifically, the cardboard is folded upwardly out of the plane of the cardboard so that at least two layers of cardboard form the right and left sides of the container. In one embodiment, the container has top load strength greater than about 800 lbs, in another embodiment greater than about 1,300 lbs. The present top load strength is in contrast to containers which have multiple layers of cardboard on the tops of the containers, but single layers of cardboard on the sides, such as the container constructed according to the description contained in U.S. Publication No. 2010/0102112, titled “Container” and assigned to Dow Agrosciences LLC, Indianapolis, Ind.

It has also been surprisingly found that a container constructed according to the methods disclosed herein can be formed such that the container has less cardboard waste which is a measure of fiber per surface area of the container. This allows for a container having increased top load strength (and thus increased stacking of containers) while at the same time using less fiber per surface area of the container. The amount of fiber used is a measure of basis weight. The basis weight measurement is the most fundamental property of cardboard. The basis weight of cardboard is the weight per unit area. This can be expressed as the weight in grams per square meter (GSM or g/m²), pounds per 1000 sq. ft or weight in Kgs or pounds per ream (500 sheets) of a specific size. The basis weight is what determines how much area the buyer of cardboard gets for a given weight. When the basis weight is expressed as ream weight, it tells the buyer how many reams he/she is getting for a given weight.

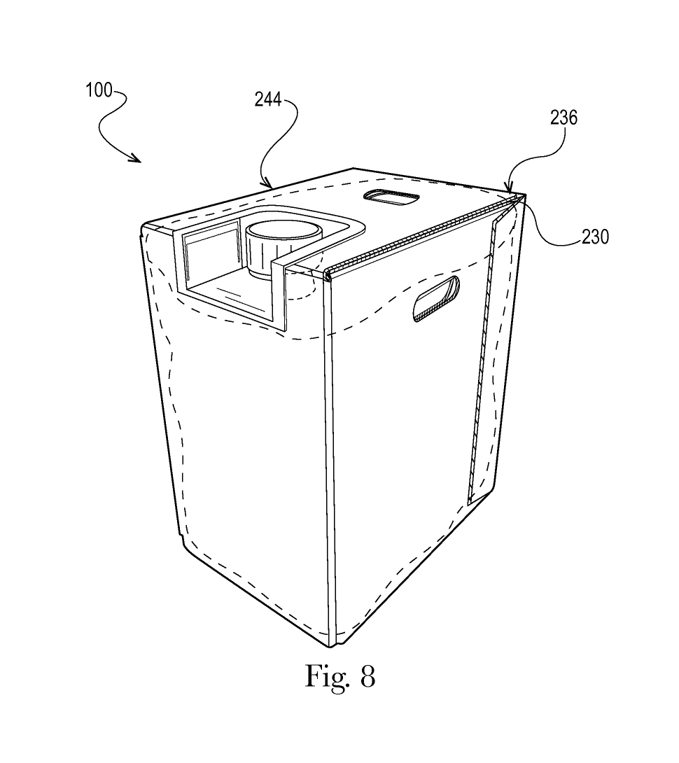

In one embodiment of the invention, the unassembled piece of cardboard has a surface area of from about 12 square feet to about 20 square feet, in another embodiment a surface area of about 13 square feet to about 15 square feet. In one embodiment, the container has a surface area of about 13.66 square feet, 2.86 feet of that surface area being waste. This container therefore uses about 1.8% less fiber than a container having the same dimensions as the container constructed according to the description contained in U.S. Publication No. 2010/0102112, as shown in FIG. 8 and the Examples section described herein.

Reference will now be made in detail to embodiments of the invention, one or more examples of which are illustrated in the drawings. Each example is provided by way of explanation of the invention, and is not meant as a limitation of the invention.

The present invention provides for a container comprising a cardboard enclosure. The container is formed from a single piece of cardboard having a folded state forming the cardboard enclosure and an unfolded state. In one embodiment, the single piece of cardboard is corrugated and has a fluted sheet between two linear boards. In another embodiment, the cardboard contains vertical rugostics. Since the cardboard container has increased top load strength from multiple layers on the side of the container, there is a decreased risk of the container bulging under stacking weight. Therefore, the cardboard container is not required to contain reinforced tape and is not required to contain reinforcing sections on the edges of the container, but one or both of the reinforcing tape and/or enforcing sections may be optionally present.

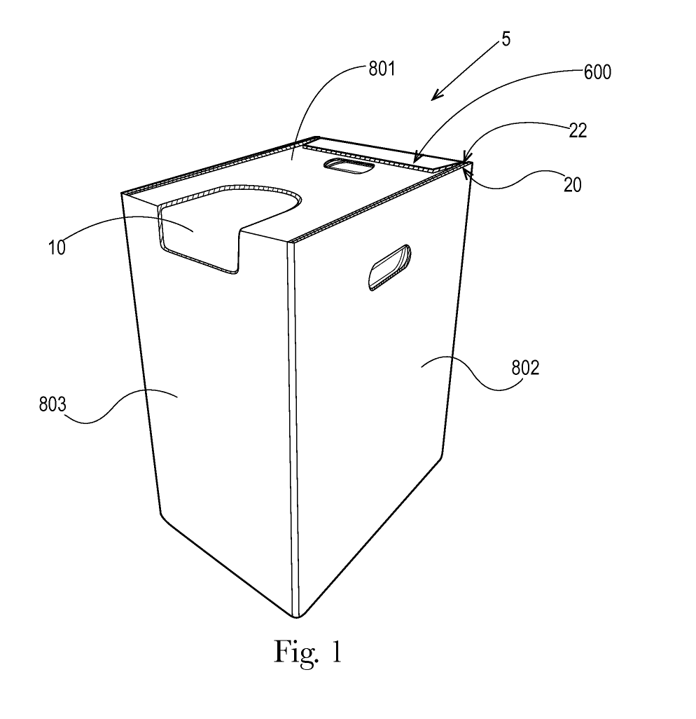

FIG. 1 depicts a container (5) comprising a cardboard enclosure in a folded position. In this representative embodiment, the cardboard enclosure has a top side, a bottom side, a front side, a back side, a right side, and a left side. In this embodiment, the assembled top side (801) and the assembled bottom side (not shown) are opposing, and the assembled right side (802) and the assembled left side (not shown) are opposing. The assembled top side (801) contains at least a portion of a pour spout opening (10) which when the cardboard container sits on a surface, is at least in part directed upwards.

In this embodiment, the assembled left side and the assembled right side (802) each comprise at least a first layer of corrugated cardboard (22) and a second layer of corrugated cardboard (20). In this embodiment, the first layer of corrugated cardboard (22) is the inner most layer and the second layer of corrugated cardboard (20) is the outermost layer. In one embodiment, the first layer of cardboard on the assembled right and left sides of the container comprises two abutting flaps. In another embodiment, the second layer of cardboard on the assembled right and left sides of the container comprises at least one panel.

In one embodiment, the flaps are rectangular in shape; in another embodiment both the flaps and the panels are rectangular in shape. In one embodiment, the panels all have the same surface area while all of the flaps have the same surface area, which is a smaller surface area than the panels. In one embodiment, the flaps and panels have edges that are flush with one another and are not tapered.

In another embodiment, the assembled right and left sides comprise a third layer of cardboard. In a variation, the third layer of cardboard is the outermost layer of cardboard and has a perimeter that generally matches the perimeter of the second layer of cardboard. In one embodiment, the third layer of cardboard comprises a panel.

In FIG. 1, the assembled front side (803) and assembled back side (not shown) each comprise a single layer of cardboard. In this embodiment, the assembled bottom side comprises a single layer of cardboard. In FIG. 1, the assembled top side (801) comprises an attachment flap (600) that is adhesively attached to the exterior surface of the assembled top side (801). The attachment flap (600) comprises at least from about 1% to about 20% of the outer surface of the assembled top side, in another embodiment from about 5% to about 15%, in another embodiment from about 5% to about 10%.

In one embodiment, the container (5) comprises at least two handle openings. In another embodiment, the container comprises at least three handle openings; in another embodiment at least four handle openings. In one embodiment, the container has a handle opening on the top side, bottom side, right side, and left side of the container. A handle opening on the right and left sides of the container is formed by a handle opening in each of the at least two layers of cardboard. In one embodiment, the handle opening is placed in a panel.

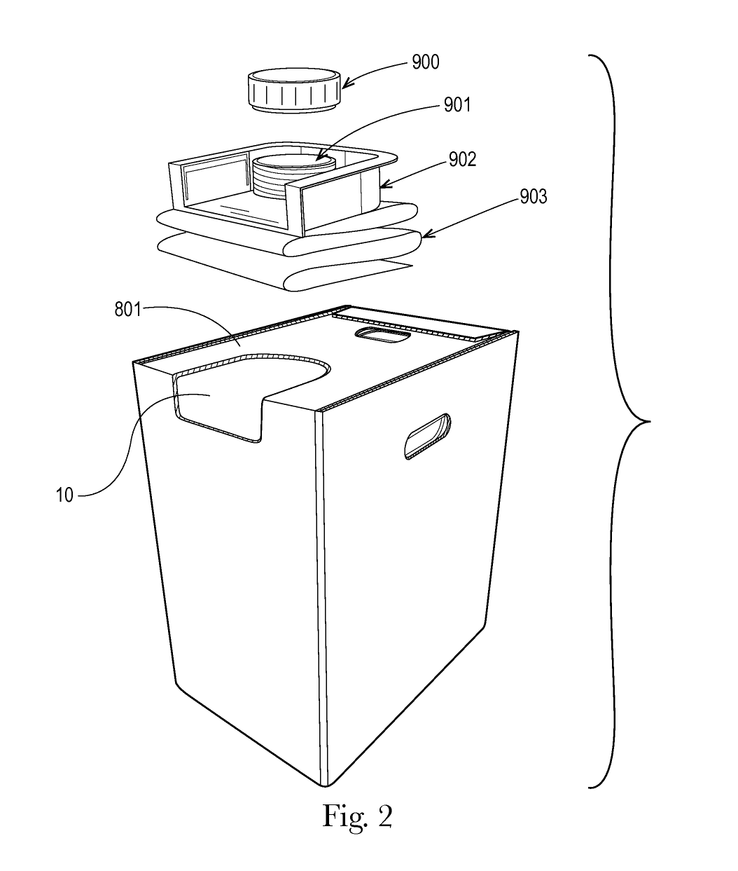

FIG. 2 depicts placing a fillable bladder (903) into the interior of a pour spout opening (10) on the assembled top side (801) of the container, the fillable bladder (903) being coupled to a holder (902) which is supported by the pour spout opening (10) which comprises at least a portion of the top side (801) of the container. The holder (902) includes an opening (901) through which a pourable product may be placed into the interior of the fillable bladder (903). The pourable product is placed into the interior of the fillable bladder (903). In one embodiment, the pourable product is placed into the fillable bladder before the bladder is placed into the pour spout opening (10) of the container. In another embodiment, the pourable product is placed into the already assembled container with fillable bladder. The opening (901) of the holder (902) is closed with a cap (900) to retain the pourable product in the interior of the fillable bladder (903).

In another embodiment, the container further comprises a nozzle functionally attached to a bladder, wherein the nozzle is located in the pour spout opening in the top side of the container. In one embodiment, the nozzle protrudes from the top side of the container.

In one embodiment, the nozzle is a press tap nozzle. The nozzle is attached to the bladder such that there is fluid communication between the nozzle and the bladder. In one embodiment, the bladder further contains a detergent composition, more specifically, an automatic dishwashing detergent composition.

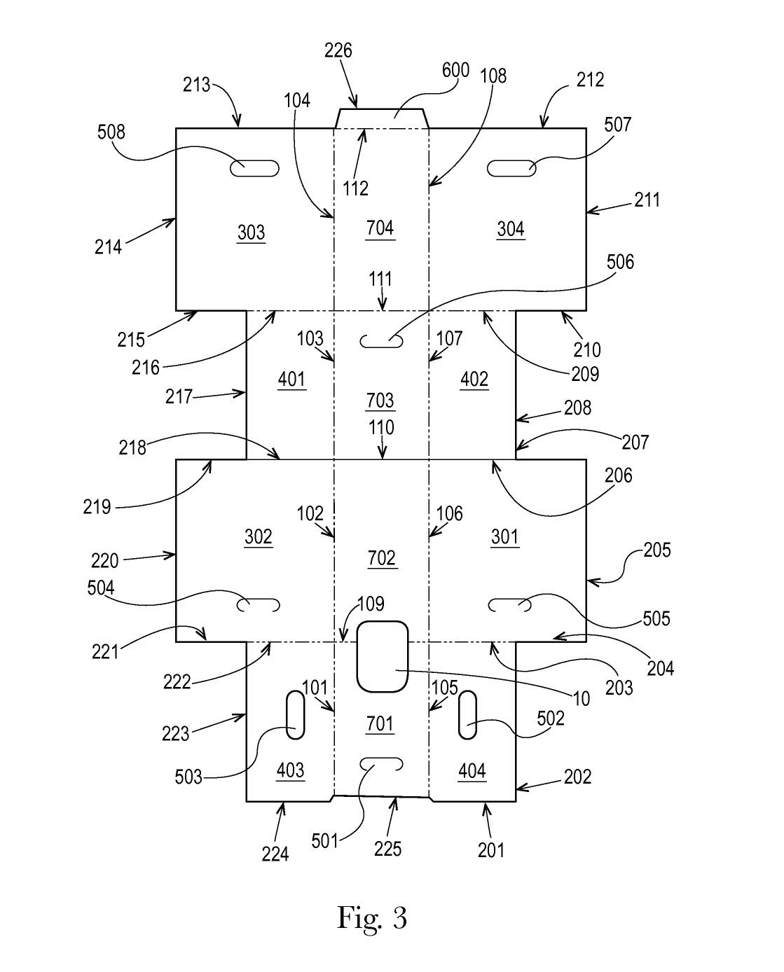

FIG. 3 depicts an unassembled container comprising a single piece of knocked down flat cardboard which folds upwardly out of the plane of the cardboard to form an enclosure. The unassembled container comprises a top side (701), a front side (702), a bottom side (703), and a back side (704). The top side (701) adjoins the front side (702) along a first fold line (109), the front side (702) adjoins the bottom side (703) along a second fold line (110), and the bottom side (703) adjoins the back side (704) along a third fold line (111). The top side (701) has edge line (225) parallel to first fold (109).

In FIG. 3, the top side (701) comprises a first left flap (403) along a fourth fold line (101) and a first right flap (404) along a fifth fold line (105). The front side (702) comprises a second left panel (302) along a sixth fold line (102) and a second right panel (301) along a seventh fold line (106). The bottom side (703) comprises a second left flap (401) along an eighth fold line (103) and a second right flap (402) along a ninth fold line (107). The back side (704) comprises a first left panel (303) along a tenth fold line (104) and a first right panel (304) along an eleventh fold line (108). In one embodiment, the back side (704) further comprises an attachment flap (600) along a twelfth fold line (112). The attachment flap (600) has edge (226) parallel to twelfth fold (112).

In FIG. 3, the first left flap (403) is immediately adjacent to the second left panel (302) along edge (222) which is perpendicular to edge (223) and parallel to edge (224). The second left panel (302) further has edges (219), (220) and (221). In addition, the first right flap (404) is immediately adjacent to the second right panel (301) along edge (203) which is perpendicular to edge (202) and parallel to edge (201). The second right panel (301) further has edge (206), edge (205), and edge (204).

In this embodiment, the second left flap (401) is immediately adjacent to the second left panel (302) along edge (218), which is perpendicular to edge (217) and parallel to edge (216). The second right flap (402) is immediately adjacent to the second right panel (301) along edge (207), which is perpendicular to edge (208) and parallel to edge (209).

In this embodiment, the first left panel (303) is immediately adjacent to the second left flap (401) along edge (215), which is perpendicular to edge (214) and parallel to edge (213). The first right panel (304) is immediately adjacent to the second right flap (402) at edge (210), which is perpendicular to edge (211) and parallel to edge (212).

In this embodiment, the cardboard container comprises a pour spout opening (10) and a first handle opening (503) located in the first left flap (403), a second handle opening (502) located in the first right flap (404), a third handle opening (504) located in the second left panel (302), a fourth handle opening (505) located in the second right panel (301), a fifth handle opening (506) located in the bottom side (703), a sixth handle opening (507) located in the first right panel (304), a seventh handle opening (508) located in the first left panel (303), and a eighth handle opening (501) located in the top side (701). When in a folded state, the handle openings line up to allow a person to place his/her hands or fingers through the handle openings for lifting and pouring of the container.

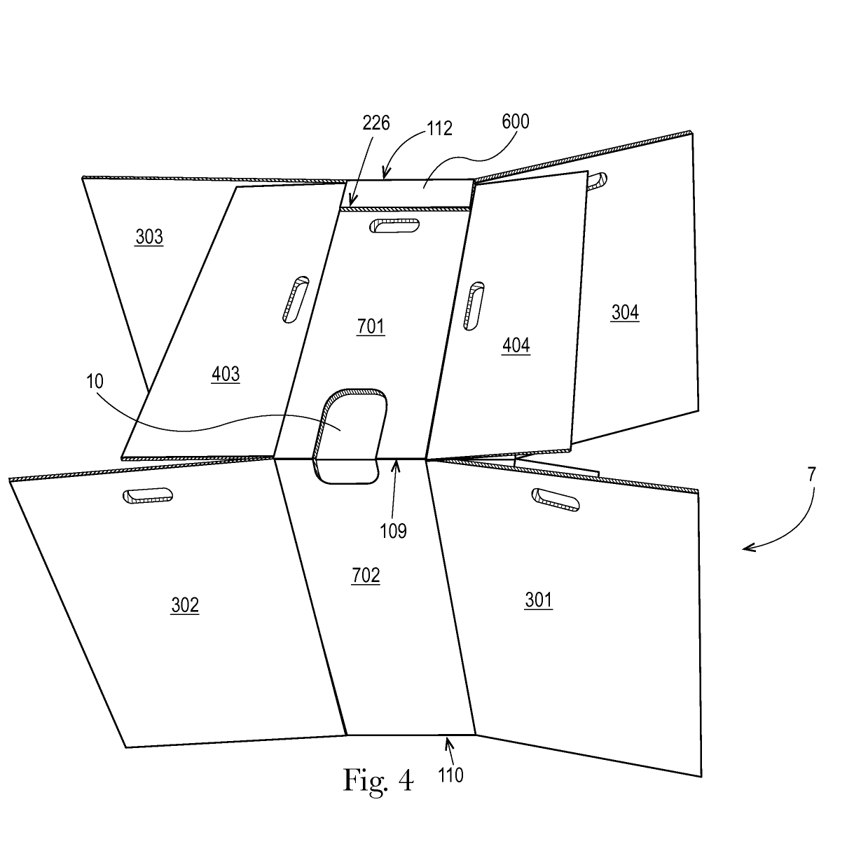

FIG. 4 depicts folding the single piece of cardboard (7) to form a cardboard enclosure having increased top load strength. The cardboard piece is folded along fold lines (109) and (110) so that the front side (702) is generally parallel with the back side (not shown), and the top side (701) is generally parallel with the bottom side (not shown). The top side (701) is shown with the majority of the pour spout opening (10) positioned upwards. The attachment flap (600) is folded along fold line (112) and is secured to the exterior surface of the top side (701) along edge (226). The attachment flap (600) may be secured by any fastening means such as glue, paste, or tape. In one embodiment, the attachment flap (600) is secured by water resistant glue. In FIG. 1, second right panel (301), first right panel (304), first right flap (404), first left panel (303), second left panel (302), and first left flap (403) are in an unfolded state.

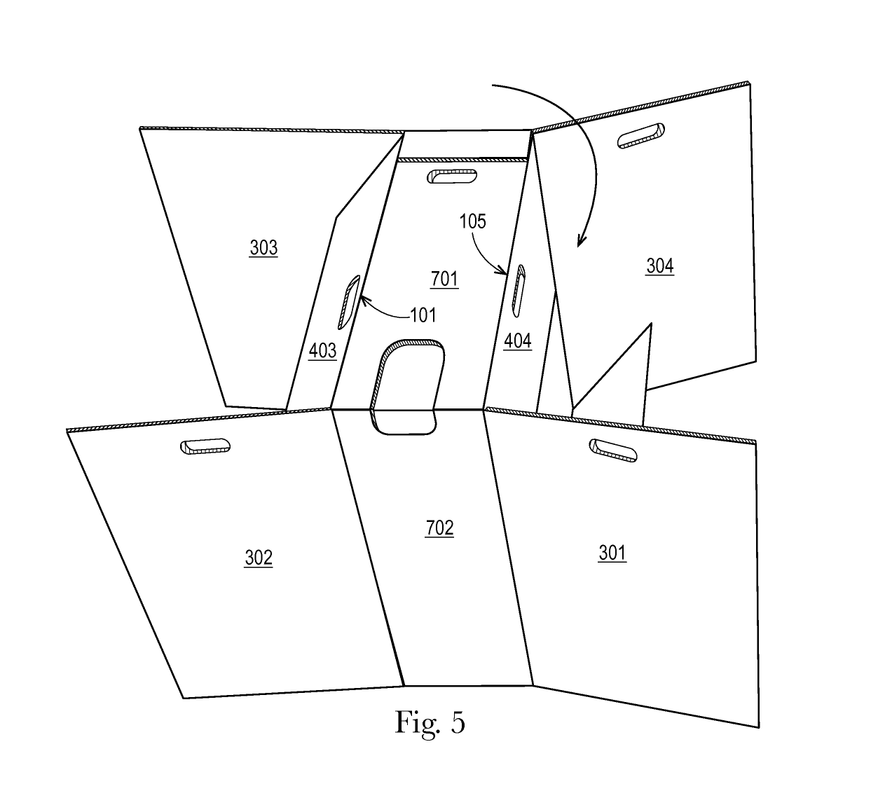

FIG. 5 depicts folding the first right flap (404) along fold line (105) so that the first right flap (404) is perpendicular to the top side (701) and front side (702). FIG. 5 further depicts folding the first left flap (403) along fold line (101), partially folded towards its final folded positions whereby the first left flap (403) is perpendicular to the top side (701). In one embodiment, the first left flap (403) is folded down before folding down the first right flap (404). In this embodiment, the first right panel (304), second right panel (301), second left panel (302), and first left panel (303) are in an unfolded state.

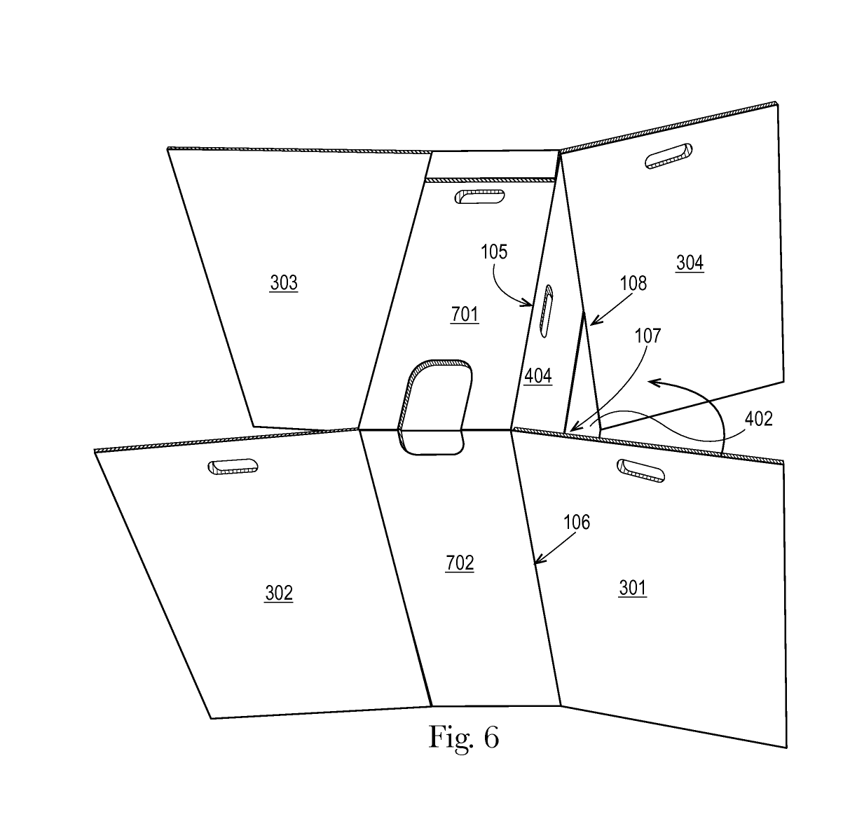

FIG. 6 depicts folding the second right flap (402) along fold line (107) so that the second right flap (402) is perpendicular to the top side (701) and front side (702). The first right flap (404) is also folded along fold line (105) so that the first right flap (404) is perpendicular to the top side (701) and front side (702), further the first right flap (404) and second right flap (402) do not overlap in this position. In one embodiment, the first right flap (404) is folded before folding the second right flap (402) to form the enclosure. In FIG. 6, the first left panel (303), the second left panel (302), the first right panel (304), and second right panel (301), are in an unfolded state.

When completing the formation of the right side of the container, in one embodiment the first right panel (304) is folded along fold line (108) so that the first right panel(304) is perpendicular to the top side (701), and wherein the first right panel (304) is parallel and adjacent to the first right flap (404) and the second right flap (402). The second right panel (301) is then folded along fold line (106) so that the second right panel (301) is perpendicular to the top side (701), and wherein the second right panel (301) is parallel and adjacent to the first right panel (304) and forms the exterior of the right side of the container. In one embodiment, the first right panel (304) is secured to the second right panel (301). In another embodiment, the second right panel (301) is folded first to be adjacent to the first right flap (404) and second right flap (402), followed by folding the first right panel (304) to be adjacent to the second right panel (301) such that the first right panel (304) forms the exterior of the right side of the container.

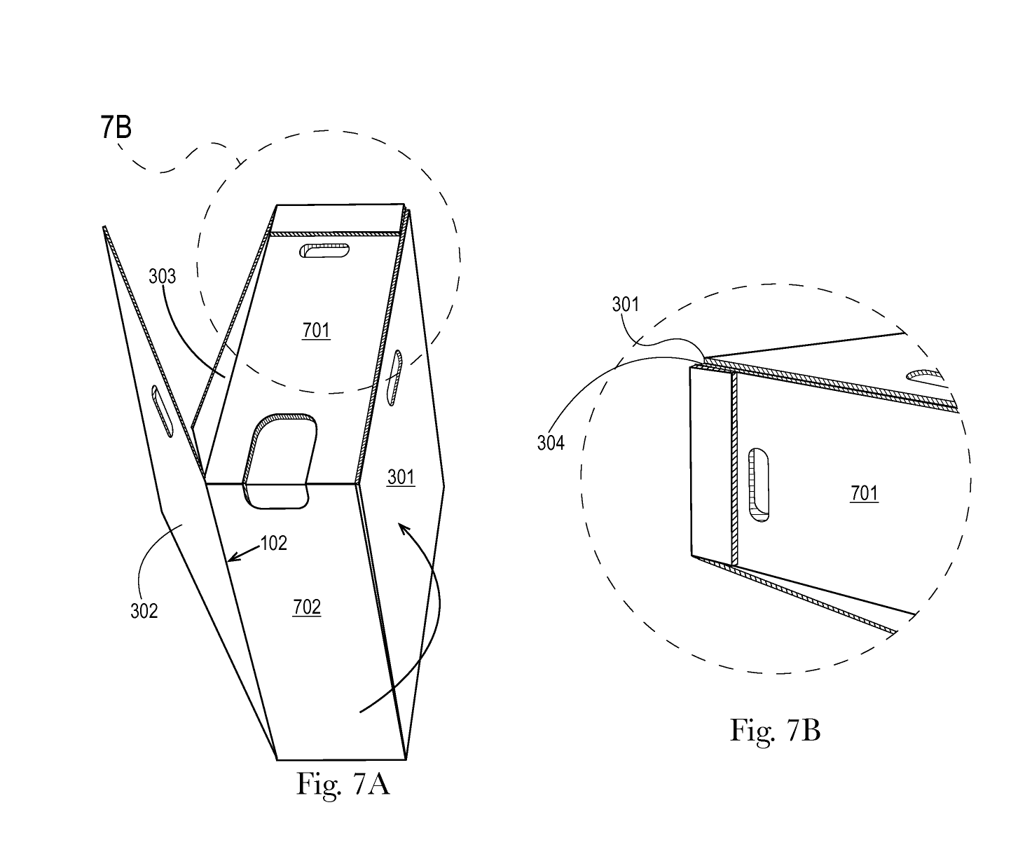

FIG. 7A depicts the second right panel (301) in the secured position adjacent to the inner first right panel (304); and the second left panel (302) being folded along fold line (102) so that the second left panel (302) is perpendicular to the top side (701) and front side (702), and the second left panel (302) is parallel to the inner first left panel (303).

In one embodiment, the left side of the container is constructed before the right side of the container; in another embodiment, the left side of the container is constructed in tandem with the right side.

FIG. 7B shows an enlarged view of the container having two layers of cardboard on the right side which is perpendicular to the top side (701). The first layer of cardboard is an outer layer of cardboard which is the second right panel (301) and the inner layer of cardboard is the first right panel (304).

### EXAMPLES

A container (100) constructed according to the description contained in U.S. Publication No. 2010/0102112, titled “Container” and assigned to Dow Agrosciences LLC, Indianapolis, Ind., was compared to the present container in the following comparative examples. The prior art container in FIG. 8 shows a top portion (103) of the container (100) having multiple top flaps, as illustrated by a first flap (230), a second flap (236), and a third flap (244).

### Example 1

### Comparative Fiber Test

The amount of fiber used is basis weight. The basis weight of paper is the weight per unit area. The weight per unit of area of the present container was compared to the weight per unit area of the container constructed according to U.S. Publication No. 2010/0102112.

| | | Waste Surface | |
|---|---|---|---|
| | Surface Area | Area | Waste % |
| Present | 13.66 square feet | 2.86 square feet | 20.9 |
| Container | | | |
| Prior Art | 9.20 square feet | 9.20 square feet | 22.7 |
| Container | | | |

The present container utilizes 13.66 square feet: 2.86 square feet is waste (20.9%). The prior art container has a sheet of 9.20 square feet: 2.11 square feet is waste (22.7%). For waste, the recycle content varies from mill to mill and paper to paper. The corrugated cardboard supplier provided an average for all cardboard since they source from a variety of mills. The average cardboard is about 30% recycled content

### Example 2

### Comparative Top Load Strength Test

A ring crush test was performed to compare the prior art container as described above and described fully in U.S. Publication No. 2010/0102112 with the container described according to the present invention. Ring Crush is a traditional test of cardboard and corrugating medium strength. Ring crush measures compression resistance, and this compression strength is considered to relate to the eventual compression strength of combined cardboard made from the component. The Ring Crush test is described in more detail in U.S. Publication No. 2010/0102112.

| | | Top Load |
|---|---|---|
| | Surface Area | Strength |
| Present | 13.66 square feet | 1300 lbs |
| Container | | |
| Prior Art | 9.20 square feet | 750 lbs |
| Container | | |

The present container has top load strength of 1300 lbs while the prior art container has a top load strength of about 750 lbs.

It should be understood that the present invention includes various modifications that can be made to the embodiments of the cardboard container as described herein as come within the scope of the appended claims and their equivalents.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Further, the dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container comprising:
(a) a cardboard enclosure having six sides, wherein the six sides comprise a top side, a bottom side, a back side, a front side, a left side, and a right side, wherein the top side and the bottom side are opposing, wherein the left side and the right side are opposing, and wherein the left side and the right side each comprise at least a first layer of cardboard and a second layer of cardboard; and
(b) a fillable bladder positioned within the cardboard enclosure, an interior of the fillable bladder being accessible through a pour spout opening in the top side of the enclosure.

2. The container according to claim 1, wherein the first layer of cardboard on the left side and right side comprises two abutting flaps.

3. The container according to claim 2, wherein the second layer of cardboard of the left side and the right side comprises a panel.

4. The container according to claim 3, wherein the first layer of cardboard is the inner most layer.

5. The container according to claim 4, wherein the second layer of cardboard is the outer most layer.

6. The container according to claim 5, wherein the left and right side further comprises a third layer of cardboard.

7. The container according to claim 6, wherein the third layer of cardboard is the outer most layer.

8. The container according to claim 7, wherein the third layer of cardboard is a panel.

9. The container according to claim 8, wherein the front side and the back side each comprise a single layer of cardboard.

10. The container according to claim 9, wherein the bottom side comprises only a single layer of cardboard.

11. The container according to claim 10, wherein the top side comprises an attachment flap.

12. The container according to claim 11, wherein the attachment flap is adhesively attached to the top side.

13. The container according to claim 12, wherein the container comprises a top load strength of greater than 800 lbs.

14. The container according to claim 13, wherein the cardboard enclosure comprises at least two Handle openings.

15. The container according to claim 14, wherein the container further comprises a nozzle functionally attached to the bladder, wherein the nozzle is located in the pour spout opening in the top side, and wherein the nozzle protrudes from the top side.

16. The container according to claim 15, wherein the bladder further contains a detergent composition.

17. The container according to claim 16, wherein the nozzle is a press tap nozzle.

18. The container according to claim 17, wherein the cardboard has vertical rugostics.

19. An unassembled container comprising single piece of cardboard which is foldable to form an enclosure, the unassembled container comprising:
a) a top side (701), a front side (702), a bottom side (703), and a back side (704), wherein the top side (701) is adjoining the front side (702) along a first fold line (109), wherein the front side (702) is adjoining the bottom side (703) along a second fold line (110), wherein the bottom side (703) is adjoining the back side (704) along a third fold line (111);
b) the top side (701) comprising a first left flap (403) along a fourth fold line (101) and a first right flap (404) along a fifth fold line (105);
c) the front side (702) comprising a second left panel (302) along a sixth fold line (102) and a second right panel (301) along a seventh fold line (106);
d) the bottom side (703) comprising a second left flap (401) along an eighth fold line (103) and a second right flap (402) along a ninth fold line (107);
e) the back side (704) comprising a first left panel (303) along a tenth fold line (104) and a first right panel (304) along an eleventh fold line (108),
wherein the back side further comprises an attachment flap (600) along a twelfth fold line (112).

20. The unassembled container of claim 19, wherein the first left flap (403) is immediately adjacent to the second left panel (302) along edge (222) and wherein the first right flap (404) is immediately adjacent to the second right panel (301) along edge (203).

21. The unassembled container of claim 20, wherein the second left flap (401) is immediately adjacent to the second left panel (302) along edge (218), and wherein the second right flap (402) is immediately adjacent to the second right panel (301) along edge (207).

22. The unassembled container of claim 21, wherein the first left panel (303) is immediately adjacent to the second left flap (401) along edge (216) and wherein the first right panel (304) is immediately adjacent to the second right flap (402) at edge (209).

23. A method of constructing a container for holding a pourable product, the method including the steps of:
obtaining a single piece of cardboard which is foldable to form the enclosure, the single piece of cardboard including:
a top side (701), a front side (702), a bottom side (703), and a back side (704), wherein the top side (701) is adjoining the front side (702) along first fold line (109), wherein the front side (702) is adjoining the bottom side (703) along second fold line (110), wherein the bottom side (703) is adjoining the back side (704) along third fold line (111);
the top side (701) comprising a first left flap (403) along a fourth fold line (101) and a first right flap (404) along a fifth fold line (105);
the front side (702) comprising a second left panel (302) along a sixth fold line (102) and a second right panel (301) along a seventh fold line (106);
the bottom side (703) comprising a second left flap (401) along an eighth fold line (103) and a second right flap (402) along a ninth fold line (107);
the back side (704) comprising a first left panel (303) along a tenth fold line (104) and a first right panel (304) along an eleventh fold line (108), wherein the back side further comprises an attachment flap (600) along a twelfth fold line (112), and further the top side (701) comprises at least a portion of a pour spout opening (10);
folding the single piece of cardboard along fold lines (111) and (110) so that the front side (702) is generally parallel with the back side (704), folding along fold line (109) so that the top side (701) is generally parallel with the bottom side (703), and folding the attachment flap (600) along fold line (112);
securing the attachment flap (600) to the top side (701) along edge (226);
folding the first right flap (404) along fold line (105) so that the first right flap (404) is perpendicular to the top side (701), folding the second right flap (402) along fold line (107) so that the second right flap (402) is perpendicular to the bottom side (703) and wherein further the first right flap (404) and second right flap (402) do not overlap;
folding the first right panel (304) along fold line (108) so that the first right panel(304) is perpendicular to the top side (701) and wherein the first right panel (304) is parallel and adjacent to the first right flap (404) and the second right flap (402);
folding the second right panel (301) along fold line (106) so that the second right panel (301) is perpendicular to the top side (701) and wherein the second right panel (301) is parallel and adjacent to the first right panel (304);
securing the first right panel (304) to the second right panel (301);
folding the first left flap (403) along fold line (101) so that the first left flap (403) is perpendicular to the top side (701), folding the second left flap (401) along fold line (103) so that the second left flap (401) is perpendicular to the bottom side (703), and wherein further the first left flap (403) and the second left flap (401) do not overlap;
folding the first left panel (303) along fold line (104) so that the first left panel (303) is perpendicular to the top side (701) and wherein the first left panel (303) is parallel and adjacent to the first left flap (403) and the second left flap (401);
folding the second left panel (302) along fold line (102) so that the second left panel (302) is perpendicular to the top side (701) and wherein the second left panel (302) is parallel and adjacent to the first left panel (303);
securing the first left panel (303) to the second left panel (302);
placing a fillable bladder (903) within a pour spout opening (10), the fillable bladder (903) being coupled to a holder (902) which is supported at the pour spout opening (10) by the container, the holder (902) including an opening (901) through which a pourable product may be placed into the interior of the fillable bladder (903);
optionally placing the pourable product into the interior of the fillable bladder (903); and
closing the opening (901) of the holder (902) to retain the pourable product in the interior of the fillable bladder (903).
